(19) United States
(12) Patent Application Publication
(10) Pub. No.: US 2024/0202516 A1
(43) Pub. Date: Jun. 20, 2024

(54) FIRST-TO-SATURATE SINGLE MODAL LATENT FEATURE ACTIVATION FOR EXPLANATION OF MACHINE LEARNING MODELS

(71) Applicant: FAIR ISAAC CORPORATION, Roseville, MN (US)

(72) Inventors: Scott Michael Zoldi, San Diego, CA (US); Joseph Francis Murray, San Diego, CA (US)

(21) Appl. No.: 18/069,163

(22) Filed: Dec. 20, 2022

(51) Int. Cl. G06N 3/08; G06N 3/045

(52) U.S. Cl. CPC G06N 3/08; G06N 3/045

(57) ABSTRACT

A method is provided for a first to saturate single modal latent feature activation network. The method includes training, based on a plurality of training examples including a plurality of input features, a first machine learning model including a hidden node. The method includes determining a plurality of subsets of the plurality of input features including a minimum combination of the plurality of input features first to cause saturation of the hidden node. The method includes determining a hidden node ordered saturation list including a subset of the plurality of subsets. The method includes generating a sparsely trained machine learning model to determine an output for a training example of the plurality of training examples based on at least one input feature of the subset included in the hidden node ordered saturation list corresponding to the hidden node. Related methods and articles of manufacture are also disclosed.

### FIELD

The present disclosure generally relates to machine learning and more specifically to first-to-saturate single modal latent feature activation to explain and interpret machine learning models.

### BACKGROUND

Machine learning models, such as neural networks, may be used in critical applications such as in the healthcare, manufacturing, transportation, financial, information technology industries, among others. In these and other applications, explanations to a user related to why the model generated a specific prediction for a particular input, what data, models, and processing have been applied to generate that prediction, and/or the like can be useful, and in some instances, required. However, conventional explainable machine learning methods inefficiently and/or inaccurately demonstrate the properties of the hidden units of the models as they fail to address the multi-modal nature of unconstrained latent feature activation. As a result, explainability methods on conventional models provide inconsistent and unreliable explanation associated with the model output.

### SUMMARY

Methods, systems, and articles of manufacture, including computer program products, are provided for generating explanations for single modal latent feature activation using first-to-saturate latent features in machine learning. In one aspect, there is provided a system. The system may include at least one processor and at least one memory. The at least one memory may store instructions that result in operations when executed by the at least one processor. The operations may include: training, based at least on a plurality of training examples including a plurality of input features, a first machine learning model including at least one hidden node. The operations further include determining, for each of the plurality of training examples and the at least one hidden node and based on the first machine learning model, a plurality of subsets of the plurality of input features including a minimum combination of the plurality of input features first to cause saturation of the at least one hidden node. The operations further include determining, for the at least one hidden node and based on the plurality of subsets of the plurality of input features for each of the plurality of training examples, a hidden node ordered saturation list including a subset of the plurality of subsets. The operations further include generating a sparsely trained machine learning model to determine an output for a training example of the plurality of training examples based on at least one input feature of the subset included in the hidden node ordered saturation list corresponding to the at least one hidden node. The at least one input feature first causes saturation of the at least one hidden node for the training example.

In another aspect, a computer-implemented method includes training, based at least on a plurality of training examples including a plurality of input features, a first machine learning model including at least one hidden node. The method further includes determining, for each of the plurality of training examples and the at least one hidden node and based on the first machine learning model, a plurality of subsets of the plurality of input features including a minimum combination of the plurality of input features first to cause saturation of the at least one hidden node. The method further includes determining, for the at least one hidden node and based on the plurality of subsets of the plurality of input features for each of the plurality of training examples, a hidden node ordered saturation list including a subset of the plurality of subsets. The method further includes generating a sparsely trained machine learning model to determine an output for a training example of the plurality of training examples based on at least one input feature of the subset included in the hidden node ordered saturation list corresponding to the at least one hidden node. The at least one input feature first causes saturation of the at least one hidden node for the training example.

In another aspect, there is provided a computer program product including a non-transitory computer readable medium storing instructions. The instructions may cause operations may executed by at least one data processor. The operations may include: training, based at least on a plurality of training examples including a plurality of input features, a first machine learning model including at least one hidden node. The operations further include determining, for each of the plurality of training examples and the at least one hidden node and based on the first machine learning model, a plurality of subsets of the plurality of input features including a minimum combination of the plurality of input features first to cause saturation of the at least one hidden node. The operations further include determining, for the at least one hidden node and based on the plurality of subsets of the plurality of input features for each of the plurality of training examples, a hidden node ordered saturation list including a subset of the plurality of subsets. The operations further include generating a sparsely trained machine learning model to determine an output for a training example of the plurality of training examples based on at least one input feature of the subset included in the hidden node ordered saturation list corresponding to the at least one hidden node. The at least one input feature first causes saturation of the at least one hidden node for the training example.

In some variations, one or more features disclosed herein including the following features can optionally be included in any feasible combination of the system, method, and/or non-transitory computer readable medium.

In some aspects, an explanation corresponding to at least one training example of the plurality of training examples is generated. The explanation includes an input feature-level contribution to the output.

In some aspects, generating the explanation includes: determining the at least one input feature of the subset first causing saturation of the at least one hidden node for the training example. The generating also includes determining, for the at least one hidden node of the sparsely trained machine learning model, a hidden node weight contribution to the output. The hidden node weight contribution corresponds to the at least one input feature. The generating also includes determining, for the at least one hidden node of the sparsely trained machine learning model, a relative importance of the at least one input feature of the subset based on the hidden node ordered saturation list, the hidden node weight contribution, and a weight corresponding to the at least one input feature. The generating also includes defining the input feature-level contribution to the output by at least aggregating a list of most important input features based on the relative importance of the at least one input feature for each subset of the plurality of subsets.

In some aspects, when saturation of the at least one hidden node for the training example occurs prior to reaching an end of the hidden node ordered saturation list, at least one remaining input feature of the subset is ignored.

In some aspects, when saturation of the at least one hidden node for the training example fails to occur prior to reaching an end of the hidden node ordered saturation list, the at least one input feature includes all input features of the subset.

In some aspects, determining the ordered hidden node saturation list for the at least one hidden node includes determining a most frequently occurring subset of the plurality of subsets of the plurality of input features causing saturation of the at least one hidden node. Determining the ordered hidden node saturation list also includes defining the ordered saturation list as the most frequently occurring subset of input features of the plurality of subsets of the plurality of input features.

In some aspects, the plurality of subsets of the plurality of input features causes hidden node saturation of the least one hidden node when a weight contribution of at least one of the plurality of subsets of the plurality of input features is greater than a predetermined saturation threshold.

In some aspects, determining the hidden node ordered saturation list of the at least one hidden node further includes ranking each input feature of the plurality of subsets of the plurality of input features based on at least one of a weight assigned to the input feature and a frequency of the input feature.

In some aspects, the weight is assigned during the training of the first machine learning model.

In some aspects, the training includes inputting the plurality of input features for each of the plurality of training examples in a predetermined order or a random order.

In some aspects, a hidden node of the at least one hidden node is determined to be antipolarized based on a first proportion of the plurality of training examples meeting a positive saturation threshold and a second proportion of the plurality of training examples meeting a negative saturation threshold.

In some aspects, the at least one antipolarized hidden node is replaced with a first newly created hidden node and a second newly created hidden node. Determining the hidden node ordered saturation list of the at least one hidden node includes: determining, for the first newly created hidden node, a first hidden node ordered saturation list of the plurality of input features causing positive saturation of the at least one hidden node. Determining the hidden node ordered saturation list of the at least one hidden node also includes determining, for the second newly created hidden node, a second hidden node ordered saturation list of the plurality of input features causing negative saturation of the at least one hidden node.

In some aspects, each of the plurality of training examples includes an input vector containing the plurality of input features.

In some aspects, the subset includes one or more input features of the plurality of input features.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to generating explanations for single modal latent feature activation using first-to-saturate latent features in machine learning, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example explainable machine learning system, consistent with implementations of the current subject matter;

FIG. 2 depicts an example process for generating a sparse network and explanations, consistent with implementations of the current subject matter;

FIG. 3 depicts a schematic representation of a machine learning model, consistent with implementations of the current subject matter;

FIG. 4 depicts an example process for determining a first-to-saturate list, consistent with implementations of the current subject matter;

FIG. 5 depicts an example of a machine learning model including an antipolarized hidden node with multiple modes of saturation, consistent with implementations of the current subject matter;

FIG. 6 depicts an example performance comparison, consistent with implementations of the current subject matter;

FIG. 7A depicts an example input hidden unit activation distribution prior to using the first-to-saturate activation, consistent with implementations of the current subject matter;

FIG. 7B depicts an example hidden unit feature distribution with using the first-to-saturate activation, consistent with implementations of the current subject matter;

FIG. 8 depicts example process for generating explanations, consistent with implementations of the current subject matter;

FIG. 9 depicts example generated explanations, consistent with implementations of the current subject matter;

FIG. 10 depicts a flowchart illustrating an example of a process for single modal latent feature activation using first-to-saturate latent features, consistent with implementations of the current subject matter;

FIG. 11 depicts an example performance evaluation, consistent with implementations of the current subject matter;

FIG. 12 depicts a block diagram illustrating an example of a computing system, consistent with implementations of the current subject matter.

When practical, like labels are used to refer to same or similar items in the drawings.

### DETAILED DESCRIPTION

Explainable machine learning models provide users with explanations regarding the predictions and outputs generated by the machine learning models. However, conventional methods for providing explanations generally have significant weaknesses. A common approach is to perturb the input data of the machine learning model to understand which features are most sensitive for a particular model output. These methods may suffer from unpredictable behavior where the perturbed input data behaves poorly due to model extrapolation effects, and so may not be satisfactory. Another explainable machine learning approach is to construct simpler models, which are intended to explain the true model in a limited region. However, explanations based on a simplified local model, instead of the actual model, do not generally accurately reflect the decision function of the original complex machine learning model. These simplified models also often do not meet the regulatory needs for explaining the decision model.

Further complicating explanation generation in machine learning is that the latent features, which are calculated at hidden nodes, are often the true quantities requiring explanation in terms of attribution to inputs. In the context of artificial neural networks, because of the nonlinearities used in the activation function (generally a sigmoid or tanh), hidden units often reach saturation. In densely connected networks, a large number of permutations of inputs can cause a hidden unit to be in the same saturated state. In other words, conventional neural networks, with dense connections and many free parameters, generally reach saturation with multiple different subsets of input features which we refer to as multi-modal saturation. This means that for a single input vector for an example record, multiple modes of saturation (and different subsets of features) exist, removing certainty form explanation assignment. In these situations, finding a unique unambiguous deterministic single modal explanations for a hidden unit is generally impossible because a single latent feature or hidden unit could have multiple behaviorally different and merged groups of inputs from often many different overlapping groups of inputs that might be responsible for saturation. These different configurations of inputs per hidden unit imply that there are multiple different explanations based on the features active for a particular input sample. Accordingly, conventional models are not capable of providing a single unambiguous deterministic single modal explanation for saturation of a hidden unit, and are thus unable to provide a single, accurate, and reliable explanation.

Consistent with implementations of the current subject matter, the explainable machine learning system described herein generates highly interpretable machine learning models (e.g., neural networks) and a specific unambiguous single modal method for producing explanations from those models. For example, the explainable machine learning system generates explanations by at least determining which input features to the machine learning models are minimally sufficient to drive hidden units of the models into saturation.

Further, the explainable machine learning system generates an accurate and consistent explanation based at least on a determined first-to-saturate subset of input features to each hidden unit. This prevents generation of multiple modes of saturation for an example, obscuring accurate explanations for the output of the model. For example, the explainable machine learning system consistent with implementations of the current subject matter generates an ordered saturation list of input features into each hidden unit of the machine learning model. In this approach, the input features may be included in the saturation list of input features until saturation is first met. The list of input features may define a unique ordered set of input features attributed to the saturation of the hidden unit, and subsequently the relative importance of each feature to that first saturation. Accordingly, the explainable machine learning system consistent with implementations of the current subject applies a first-to-saturate principle, which is applied during both training and inference.

As a result, the explainable machine learning system described herein excludes multi-modal saturation and the associated ambiguity in providing explanations, improving the accuracy, reliability, and consistency of explanations provided by the explainable machine learning system. Moreover, the explainable machine learning system described herein generates a highly interpretable sparse machine learning model based on the ordered set of input features so that the output of the model can be directly explained in terms of either a set of latent feature modes or a set of ranked input features that are significant contributors to the output decision. Additionally and/or alternatively, the explainable machine learning model consistent with implementations of the current subject matter reduces the computational burden of providing an accurate and reliable explanation at least because the explainable machine learning system may only consider the subset of input features and/or hidden nodes based on the first-to-saturate principle. Therefore, the explainable machine learning system described herein produces unambiguous explanations by at least applying the first-to-saturate principle, generating highly interpretable hidden units, and generating an unambiguous deterministic single modal explanation based on a deterministic ordered set of features in priority order to constrain and determine the minimum set of features to saturate the hidden units. The explainable machine learning system applies internal weights, activations, and saturation states of the machine learning model. As such, the explainable machine learning system provides a direct unambiguous explanation of the model used for generating outputs.

As noted herein, the generated explanations are determined using a unique ordered list (e.g., per hidden unit per training example) of input features to the hidden unit ranked by their contribution to the network output value. Further, by consolidating and rank ordering the input features of the ordered list of input features driving saturation of each hidden unit over the entire training batch, the explainable machine learning system determines overall rank-ordered lists, which can be used for feature selection, as well as for enforcing simplified neural network structure (e.g., by masking the weight matrix to only allow feature combinations already proven relevant based on their subset of the input features driving hidden units to saturation).

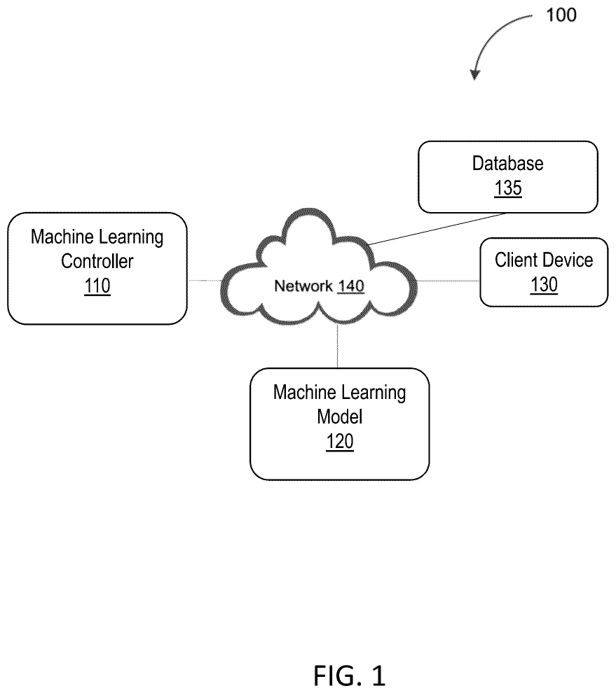

FIG. 1 depicts a system diagram illustrating an example of an explainable machine learning system 100, consistent with implementations of the current subject matter. Referring to FIG. 1, the explainable machine learning system 100 may include a machine learning engine 110, a machine learning model 120, a database 135, and a client device 130. The machine learning engine 110, the machine learning model 120, the database 135, and the client device 130 may be communicatively coupled via a network 140. The network 140 may be a wired network and/or a wireless network including, for example, a wide area network (WAN), a local area network (LAN), a virtual local area network (VLAN), a public land mobile network (PLMN), the Internet, and/or the like. In some implementations, the machine learning engine 110, the machine learning model 120, the database 135, and/or the client device 130 may be contained within and/or operate on a same device. It should be appreciated that the client device 130 may be a processor-based device including, for example, a smartphone, a tablet computer, a wearable apparatus, a virtual assistant, an Internet-of-Things (IOT) appliance, and/or the like.

The machine learning engine 110 includes at least one data processor and at least one memory storing instructions, which when executed by the at least one data processor, perform one or more operations as described herein. The machine learning engine 110 train the machine learning model 120 based on one or more training examples including one or more input features. As described herein, the one or more training examples may each include an input vector containing a plurality of input features.

In some implementations, the machine learning engine 110 trains the machine learning model 120 based on all of the plurality of input features. In this example, the machine learning engine 110 trains the machine learning model 120 as a dense model or network. Additionally and/or alternatively, the machine learning engine 110 trains the machine learning model 120 based on a subset of the input features, such as the subset of input features included in the ordered saturation list described in more detail below. In this example, the machine learning engine 110 trains the machine learning model 120 as a sparse model or network, since the machine learning model 120 is trained based on only a subset of the input features. In some implementations, the input features included in the subset of the input features may be assigned a non-zero weight, while the input features of the plurality of input features not included in the subset of the input features may be assigned a zero weight. In this way, only the input features included in the subset of the input features may contribute to the output of the machine learning model 120, such as the sparsely trained machine learning model 120.

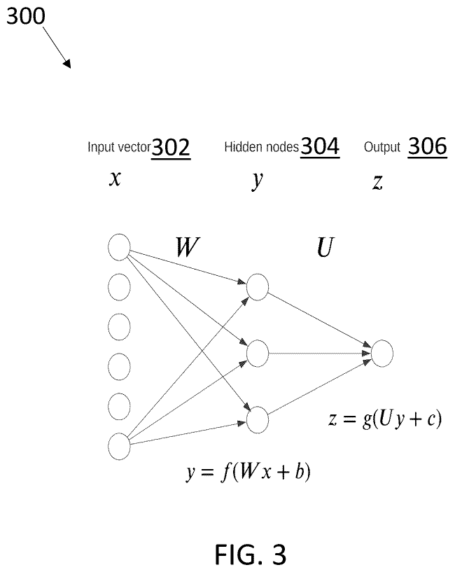

The machine learning model 120 may include a neural network, and/or the like. FIG. 3 schematically depicts an example 300 of the machine learning model 120. The machine learning model 120 may include an input 302, one or more (e.g., one or a plurality) of hidden nodes 304, which may also be referred to herein as hidden units, and an output 306. The input 302 may include training examples including a plurality of input features. Each of the plurality of training examples includes an input vector x containing the plurality of input features. The machine learning model 120 may be used in the context of medical images or medical records (e.g., transactional medical records), transactional logistics records, transactional manufacturing records, transactional financial records, and/or the like. The one or more input features may include transaction records, transaction types, information associated with the transaction records such as a time, date, or location, user information associated with a user (e.g., entity) performing the transaction, and/or the like.

The machine learning engine 110 may train the machine learning model 120 to generate the output (shown as z) 306 by, for example, inputting the plurality of input features (and corresponding training examples) and/or the subset of the plurality of input features to the one or mode hidden nodes. For example, to train the dense machine learning model 120, the machine learning engine 110 may input all of the plurality of input features (and corresponding training examples), and/or assign weights to all of the plurality of input features, to the one or mode hidden nodes. Additionally and/or alternatively, to train the sparse machine learning model 120, the machine learning engine 110 may input the subset of the plurality of input features and/or assign non-zero weights to only the subset of the plurality of input features, to the one or mode hidden nodes.

The one or more hidden nodes (shown as y) 304 may be positioned between the input 302 and the output 306 of the machine learning model 120. Each hidden node 304 may produce a defined output based on the inputted one or more input features. For example, each hidden node may be associated with an output for which a desired explanation is provided. As an example, a hidden node may be associated with existence of a medical condition, non-existence of a medical condition, fraudulent behavior, non-fraudulent behavior, and/or the like.

At the one or more hidden nodes, weights (e.g., zero or non-zero weights) are applied to the input features. The weighted input features are directed through an activation function as an output of the one or more hidden nodes. In other words, the one or more hidden nodes perform linear or nonlinear transformations of the one or more input features of the machine learning model 120. The one or more hidden nodes may be arranged into one or more hidden layers. As an example of a single hidden layer, the following notation may be used: the activation function may be denoted as f(⋅) and g(⋅). Referring to FIG. 3, the hidden-layer activation is denoted as y, the m-by-n weight matrix is denoted as W, the bias vector is denoted as b, and the non-linearity activation function is denoted as f(⋅), such that y=f(Wx+b). At the hidden node level, yᵢ=f(wᵢ·x+bᵢ) with wᵢ the i-th row vector of W. Further, the output layer is denoted as z=g(Ux+c), where the non-linearity g(⋅) is often different from f(⋅). As described in more detail below, the machine learning engine 110 generates an ordered saturation list (also referred to herein as a hidden node ordered saturation list) of the subset of the input features into f(⋅), which are included until saturation of the corresponding hidden node is met.

Consistent with implementations of the current subject matter, the activation function is generally described herein as tanh(⋅) nonlinearity, which has natural concepts of positive and negative saturation. However, the hidden node 304 may include a rectified linear unit (ReLU) activation function. The ReLU activation function does not generally have an upper limit, and so the corresponding hidden node does not generally positively saturate (unlike sigmoid non-linearities). Generally, once hidden nodes reach saturated values, they can become more difficult to train, due to the gradients becoming smaller the further the node is pushed into saturation. Techniques like ReLU and batch normalization may be used to avoid this issue. Batch normalization with ReLU units does affect a type of squashing function. However, tanh(⋅) (or other saturating nonlinearities) may be implemented to improve the stability and robustness of training. The first-to-saturate principle (with saturating non-linearities) may also address the vanishing gradient problem, in that the activations will be limited as units first reach saturation.

Referring back to FIG. 1, the database 135 may store one or more input data and/or output data, as described herein. For example, the database 135 may store input data, such as one or more input features. As noted, the one or more input features may be associated with a transaction and/or a user corresponding to the transaction. For example, the one or more input features may include may be real world and/or historical data collected based on transactions made by one or more entities. In some implementations, the one or more input features stored in the database 135 may include a customer, an account, a person, a credit card, a bank account, or any other entity whose behavior is being monitored and/or is otherwise of interest, and/or the like, a plurality of transactions (e.g., purchases, sales, transfers, and/or the like), a class (e.g., a credit default, a fraudulent card transaction, a money laundering transaction, and/or the like) assigned to each of the plurality of transactions, an entity associated with each of the plurality of transactions, a time point associated with each of the plurality of transactions, and/or the like.

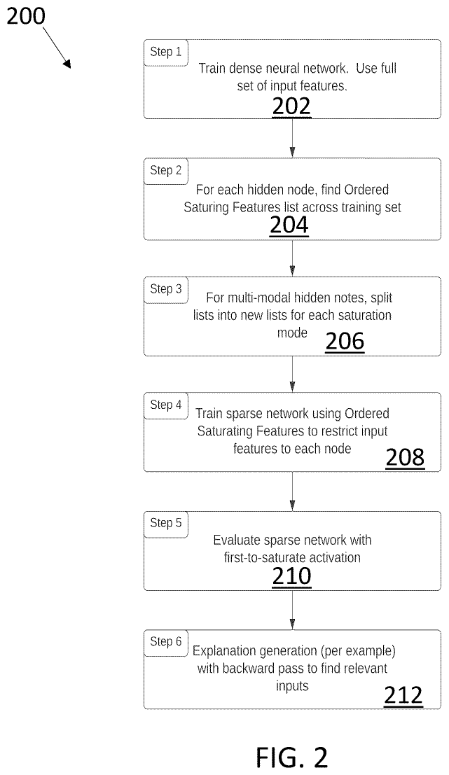

FIG. 2 depicts an example process 200 for generating a sparsely trained machine learning model and for providing explanations of single modal latent feature activation networks using first-to-saturate latent features, consistent with implementations of the current subject matter. Accordingly the explainable machine learning system 100 generates a highly interpretable neural network (e.g., the machine learning model 120) and a specific unambiguous single modal method for producing explanations from those models.

At 202, the machine learning engine 110 may train a first machine learning model, such as a dense neural network, based on a plurality of training examples including a plurality of input features, such as a plurality of input features contained within an input vector. The dense neural network may be trained based on a full set of the input features. In other words, the machine learning engine 110 may train the dense neural network based on a dense weight matrix including the plurality of input features and/or corresponding weights assigned to the plurality of input features, such that any hidden node of the dense neural network can receive any one or more of the plurality of input features. Thus, by at least training the machine learning model 120, the machine learning engine 110 may collect the saturation properties and activation modes for saturating each hidden node of the machine learning model 120.

The machine learning engine 110 may train the dense neural network to minimize misclassification using a loss function. The machine learning engine 110 may also regularize the weight matrix by adding a penalty on W to the cost function to control complexity. The loss function may include an L₁ loss, which is the sum of weights Σ|wᵢⱼ, and L₂ loss, which is the sum of squared weights Σ|wᵢⱼ|². The L₁ and L₂ constraints (e.g., loss functions) may be implemented as additional terms to be minimized during the gradient descent training of the machine learning model 120 (e.g., the dense neural network). Training the machine learning model to minimize the regularized loss functions may result in fewer input features of the one or more input features having significant contributions to activation or saturation of a hidden node of the machine learning model and removes unnecessary spurious multi-modal behaviors. The incorporation of the regularized loss functions may further improve transparency within the machine learning model 120 and may further improve the interpretable and single modal explainable machine learning model described herein.

Referring again to FIG. 2, at 204, the machine learning engine 110 determines an ordered saturation list including a subset of the plurality of features for each hidden node of the machine learning model 120, such as the dense neural network. After training the network to completion the machine learning engine 110 determines a first-to-saturate list for each example and for each hidden node (yᵢ). The first-to-saturate list, also described herein as the ordered saturation list, provides the importance of each input feature in priority ordering in driving the corresponding hidden node to saturation, as a measure across the plurality of training examples. In other words, the ordered saturation list may be the rank-ordered list of the subset of input features in input x that includes the minimum combination of the input features that are sufficient to drive the hidden unit y; into saturation.

The subset of input features may include one or more features of the plurality of input features inputted to the hidden node. The machine learning engine 110 determines the subset causes saturation of the hidden node when a weight contribution of the subset meets (e.g., is greater than or equal to) a predetermined saturation threshold. In some implementations, the weight contribution is determined by at least aggregating (e.g., totaling) an absolute value of a weight assigned to each of the plurality of input features of the subset of the plurality of input features. For example, the saturation threshold may be 0.95 such that the hidden node is considered saturated when |yᵢ |>0.95. In other implementations the saturation threshold may be 0.85, 0.90, 0.97, 0.99, and/or other ranges therebetween, greater, or lesser. The absolute value of the weight contribution is used so that the input features having the largest magnitude weights are included as part of the subset, regardless of the sign (e.g., negative or positive) of the weights. However, the sign (e.g., positive or negative) may still be considered depending on whether the machine learning engine 110 determines the hidden node is antipolarized, or is positively or negatively saturated.

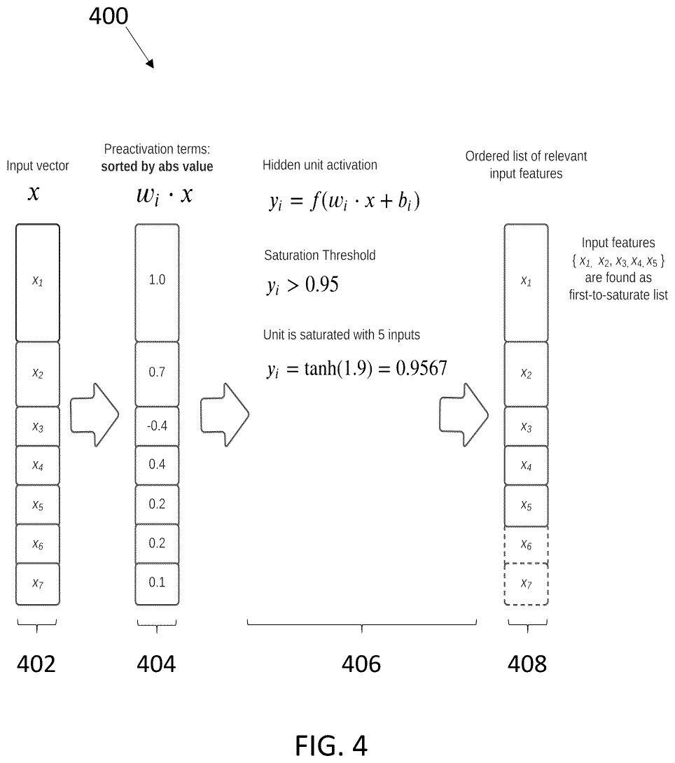

FIG. 4 shows an example 400 of determining the first-to-saturate list (e.g., the ordered saturation list of the subset of plurality of input features) for a hidden node y; that includes the subset of the plurality of input features that are the minimal combination of input features to allow the hidden node y; to reach saturation, consistent with implementations of the current subject matter. In other words, FIG. 4 depicts an example of determining the first-to-saturate feature list for a particular hidden unit for a training example with the subset of input features ranked in ordered priority. Referring to FIG. 4, at 402, the machine learning engine 110 provides a training example including an input vector x containing a plurality of input features to a hidden node yᵢ. As shown in FIG. 4, the input vector x includes the plurality of input features as {x₁, x₂, x₃, x₄, x₅, x₆, x₇}. At 404, the corresponding weights or preactivation terms associated with each of the plurality of input features (x₁, x₂, x₃, x₄, x₅, x₆, x₇) are sorted by absolute value to rank the plurality of input features based on the magnitude of the terms, regardless of the sign of the terms. In this example, the preactivation terms are provided as a vector {1.0, 0.7, −0.4, 0.4, 0.2, 0.2, 0.1} corresponding to the plurality of input features as {x₁, x₂, x₃, x₄, x₅, x₆, x₇}. In some implementations, the machine learning engine 110 sorts the plurality of input features using the natural order of the preactivation terms, in which case fewer input features are generally needed to saturate the hidden unit, as only those contributions in the same sign as the preactivation value are used. The machine learning engine 110 may alternatively employ a variety of other sorting techniques.

At 406, the hidden node yᵢ receives the input vector of the plurality of input features and the corresponding weight vector including the sorted corresponding preactivation terms. In this example, the hidden node yᵢ is represented by activation function yᵢ=f(wᵢ·x+b₁), where bᵢ=0, and wᵢ·x is the preactivation term and input matrix. Further, in this example, the predetermined saturation threshold is yᵢ>0.95. As a result, the hidden node is saturated with five input features. For example, the aggregated absolute value of the weights corresponding to the first five input features in the input vector is 1.9. Applying the aggregated absolute value to the activation function, yᵢ=tanh(1.9)=0.9567. Thus, as shown at 408, the first-to-saturate list for the hidden node yᵢ is {x₁, x₂, x₃, x₄, x₅}. This subset of input features was minimally sufficient for the hidden node to saturate since its weight contribution of 1.9 is meets the saturation threshold (1.8318) needed for |yᵢ|>0.95 (e.g., the predetermined saturation threshold). In some implementations, the aggregated total of the activations may reach a negative saturation first (for activation yᵢ<−0.95), in which case the unit is considered to be negatively saturated, and the first-to-saturate list would contain those input features needed to reach that negative saturation.

In some implementations, the machine learning engine 110 determines an ordered saturation list of the plurality of input features causing the saturation of the hidden node for each hidden node of the machine learning model 120 and based on the subset of the plurality of input features for each of the plurality of training examples. To determine the overall ordered saturation list, the machine learning engine 110 may determine a most frequently occurring subset of the plurality of input features causing saturation of the hidden node. In such instance, the machine learning engine 110 would define the overall ordered saturation list as the most frequently occurring subset of the plurality of input features. Referring to the example shown in FIG. 4, the machine learning engine 110 would define the overall saturation list as {x₁, x₂, x₃, x₄, x₅} when the subset {x₁, x₂, x₃, x₄, x₅} is found as the first-to-saturate most frequently across the plurality of training examples. Accordingly, the machine learning engine 110 provides a single unique deterministic mode of saturation including a single subset of the plurality of input features responsible for saturating a corresponding hidden node of the machine learning model 120.

Referring back to FIG. 2, at 206, the machine learning engine 110 splits the first-to-saturate list into two lists (or determines two lists) corresponding to a first-to-negatively saturate list and/or a first-to-positively saturate list. In some instances, a hidden node may be antipolarized, and as a result may be multi-modal (e.g., have multiple modes of saturation, including one or more modes of positive saturation and one or more modes corresponding to negative saturation), in which case the engine 110 may construct multiple first-to-saturate lists.

For example, the machine learning engine 110 may determine that a hidden node has significant saturation at both positive and negative values across the plurality of training examples. These cases are often the result of disjoint subsets of input features (e.g., polarized saturation modes), each leading to saturation of two polarities. As described herein, having multiple saturation modes can be problematic for explainability, transparency, and interpretability of the machine learning model 120. As an example, a single hidden node may respond strongly to input features {x₁, x₂} or {x₃, x₄}, and assigning a human-interpretable meaning to such a hidden node is generally more difficult—these two saturation modes could be paths both leading to positive saturation, both leading to negative saturation, or one positive and one negative saturation.

The machine learning engine 110, consistent with implementations of the current subject matter, prevents such explainability difficulties caused by antipolarized hidden nodes. For example, the machine learning engine 110 may determine the hidden node is antipolarized based on a first proportion of the plurality of training examples meeting a positive saturation threshold and a second proportion of the plurality of training examples meeting a negative saturation threshold. In other words, the machine learning engine 110 determines the hidden node is antipolarized if it saturates at both the positive and negative extreme for more than a defined percentage threshold (e.g., an antipolarized threshold) of training examples. For antipolarized hidden nodes, the machine learning engine 110 helps resolve explainability issues by, for example, splitting the hidden node into two newly created hidden nodes and/or determining two ordered saturation lists—for a first newly created hidden node, a first ordered saturation list of the plurality of input features causing positive saturation of the hidden node (corresponding to one of the newly created nodes) and for a second newly created hidden node, a second ordered saturation list of the plurality of input features causing negative saturation of the hidden node (corresponding to the other one of the newly created nodes). In other words, based on a determination a hidden node is antipolarized, the machine learning engine 110 creates two new hidden nodes (e.g., a positive hidden node and a negative hidden node) corresponding to the antipolarized hidden node. As noted, the newly created positive and negative polarized hidden nodes each have single or multiple modes of saturation.

As an example, in some implementations, after training of the dense network is complete, the machine learning engine 110 determines the per-example saturation lists for each example per hidden node and combines those lists to form an aggregate ordered saturation list. As described herein, the ordered saturation list may be per hidden unit, as aggregated over all the training examples. In some implementations, however, the machine learning engine 110 determines a hidden node is antipolarized, such as when a first proportion or ratio (e.g., a percentage) of training examples of the plurality of training examples meets (e.g., is greater than or equal to) a positive saturation threshold, and a second proportion or ratio (e.g., a percentage) of training examples of the plurality of training examples meets (e.g., is greater than or equal to) a negative saturation threshold.

If the machine learning engine 110 determines both the first proportion of training examples meets the positive saturation threshold and the second proportion of training examples meets the negative saturation threshold, the machine learning engine 110 determines the first ordered saturation list including the plurality of input features causing positive saturation of the hidden node and the second ordered saturation list including the plurality of input features causing negative saturation of the hidden node. To do so, the machine learning engine 110 may apply the first-to-saturate principle, as described herein.

Additionally and/or alternatively, if the machine learning engine 110 determines the first proportion of training examples meets the positive saturation threshold and the second proportion of training examples fails to meet the negative saturation threshold or alternatively, the first proportion of training examples fails to meet the positive saturation threshold and the second proportion of training examples meets the negative saturation threshold, the machine learning engine 110 compares the first proportion to the second proportion. When the machine learning engine 110 determines, based on the comparison, the first proportion (associated with positive saturation) is greater than the second proportion (associated with negative saturation), the machine learning engine 110 generates only the first ordered saturation list including the plurality of input features contributing to positive saturation of the hidden node. Otherwise, when the machine learning engine 110 determines, based on the comparison, the first proportion (associated with positive saturation) is less than the second proportion (associated with negative saturation), the machine learning engine 110 generates only the second ordered saturation list including the plurality of input features contributing to negative saturation of the hidden node.

In some implementations, the machine learning engine 110 determines an average number of input features needed to saturate (e.g., positively saturate and/or negatively saturate). In other words, the machine learning engine 110 determines the subset of the plurality of input features including the minimum combination of input features that causes saturation (e.g., positive and/or negative saturation). The machine learning engine 110 determines the ordered saturation list (e.g., the first ordered saturation list and/or the second ordered saturation list) as the most frequently occurring minimum combination of input features causing saturation across the plurality of training examples. Additionally and/or alternatively, the machine learning engine 110 determines the ordered saturation list using one or more other techniques for ranking and filtering the ordered saturation lists for each training example, such as aggregating the preactivation values of the subset of input features, implementing a binary classifier (e.g., single output node) by backpropagating the weighted contribution to the output node to provide additional evidence-based weighting to the ordered saturation list of input features, and/or the like.

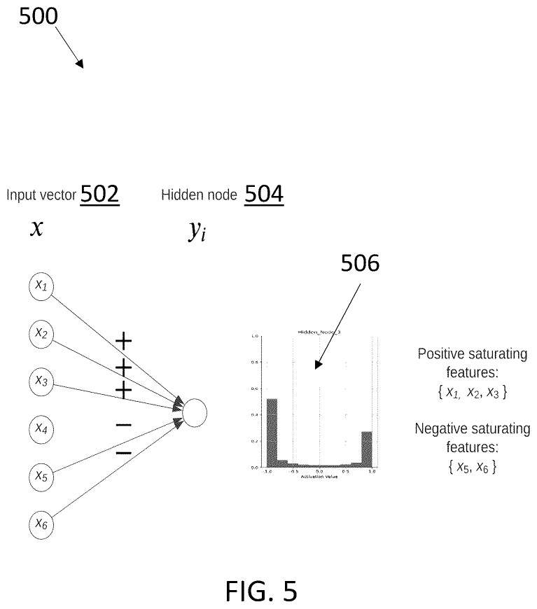

FIG. 5 depicts an example 500 of the machine learning model 120 including an antipolarized hidden node 504, consistent with implementations of the current subject matter. In this the antipolarized threshold may be 1% for a rare event (e.g., fraud, etc.), and the machine learning engine 110 determines the subset of plurality of input features associated with the rare event (e.g., those input features indicating fraud). Other antipolarized thresholds may be implemented, such as 1% to 5%, 5% to 10%, 10% to 25%, or the like. Referring to FIG. 5, the machine learning engine 110 determines the hidden node 504 is bimodal since it has signification saturation at both the positive and negative extremes, as shown in the graph 506. In this example, separate sets of input features of the input vector 502 are found to contribute to positive (shown with “+”) and negative saturation (shown with “−”). In some implementations, a feature labeled with a “+” may have a negative weight and contribution, as it may still have a large magnitude. Referring to the example 500 shown in FIG. 5, some input features, such as x₄, do not contribute to a saturation mode and are thus omitted from connecting to hidden node yᵢ during retraining or at inference. Accordingly, in this example, the machine learning engine 110 determines that input features {x₁, x₂, x₃} define a first ordered saturation list of a subset of the input features that contribute to positive saturation, since the aggregated weights associated with input features {x₁, x₂, x₃} is greater than a positive saturation threshold, while input features {x₄, x₅} define a second ordered saturation list of a subset of the input features that contribute to negative saturation, since the aggregated weights associated with input features {x₄, x₅} is greater than a negative saturation threshold. Each of the first and second ordered saturation lists leads to a more interpretable sparsely weighted machine learning model trained based on the first and second ordered saturation lists.

Referring back to FIG. 2, the machine learning engine 110 may train a highly explainable sparse neural network using the first-to-saturate list (e.g., the determined ordered saturation list) of the subset of the plurality of input features causing saturation of the hidden node. In doing so, the machine learning engine 110 may restrict the input features for each hidden node to those input features of the corresponding subset of the plurality of input features causing saturation. For example, the machine learning engine 110 may assign the subset of the plurality of input features non-zero value weights, while assigning zero value weights to the plurality of input features not included in the subset. In other words, the machine learning engine 110 may generate a sparsely trained machine learning model by at least training (e.g., retraining) the first machine learning model (e.g., the dense neural network) based at least on the determined ordered saturation list of the plurality of input features. The sparsely trained machine learning model may be highly explainable and provide reliable and consistent explanations.

For example, the resulting sparsely trained network may have a sparse input feature-to-hidden node weight matrix, e.g., with only about 10% of the weights being non-zero. The sparsely trained network retains a large amount of the predictive power of the original dense network, while providing a high level of explainability and transparency at the per-example level. Accordingly, the determined ordered saturation list provides input feature importance in capturing the behaviors that drive the outcomes of a dense network, and thus provides a natural way to construct highly explainable sparsely trained neural networks.

For example, in training (e.g., retraining) the sparsely trained neural network, each hidden node of the sparse network may receive a different number and/or order of allowed input features compared to the dense neural network, and may be restricted to the determined subset of the plurality of input features. In some implementations, a binary sparse matrix M of the same size as W∈R^{{m×n}} is used for masking, to ensure that only weights in the ordered saturation lists are allowed to be non-zero during training of the sparse network. During training of the sparse network by the machine learning engine 110, the forward pass uses the first-to-saturate principle, which for each example only considers those input features needed to saturate a hidden node. If an input feature is not needed to saturate a hidden node, the machine learning engine 110 assigns the input feature a zero value weight for further determinations (e.g., forward-pass activations and/or the gradient updates). In turn, the output unit activation is also found by implementing the first-to-saturate principle, and so hidden nodes of the sparse neural network not needed to saturate the output unit are similarly set to zero.

To evaluate the detection performance of the generated sparse network, an experiment was performed using a transactional fraud detection data set with several million transactions (e.g., training examples) across time for many users, and from each transaction, in this experiment, 144 input features were constructed. The performance metric used in this experiment is left-area-under-curve (LAUC), which is the area under the receiver operating characteristic curve to the left of a threshold. The LAUC metric is used in rare-event problems, such as fraud detection, disease identification, and/or the like, because the operating point needs to be at a fairly low false positive rate, to avoid impacting large numbers of legitimate customers or healthy patients, respectively. In this example, the threshold of non-fraud false positive rate<1% was used for the region where LAUC is calculated.

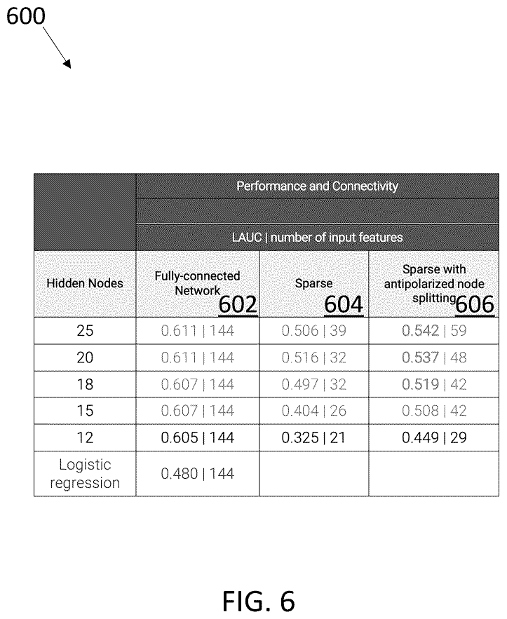

FIG. 6 illustrates a table 600 showing the results of the experiment, consistent with implementations of the current subject matter. As shown in the table 600, the metric corresponding to the trained dense (fully-connected) network (e.g., the dense machine learning model 120 trained on all of the plurality of input features) is shown in the first column 602, the metric corresponding to the trained sparse network (e.g., the sparse machine learning model 120 trained or retrained based on the subset of the plurality of input features included in the ordered saturation list for each hidden node) is shown in the second column 604, and the metric corresponding to the trained sparse network using antipolarized node splitting (e.g., the sparse machine learning model 120 trained or retrained based on the subset of the plurality of input features included in the first ordered saturation list corresponding to positive saturation and the second ordered saturation list corresponding to negative saturation for each hidden node) is shown in the third column 606.

As shown in the table 600, the “sparse with antipolarized node splitting” network shown in the column 606 generally performed best, but note that this case generally selected more input features than the other case from the other sparse network shown in the middle column of the same row. The last row shows the performance of a logistic regression model when trained on the full set of 144 input features. For certain configurations of the sparse networks (the first four rows), these networks outperform logistic regression (on LAUC) while using many fewer input features. Also, these sparse networks also outperform logistic regression, which can be considered a baseline explainable model.

Further, as shown in the table 600, the total number of input features used in the sparse cases (e.g., the second column 604 and the third column 606) is much lower than the total number of input features (e.g., shown in the first column 602). This means that isolating modes of behavior helps isolate driving features. For example, with 20 hidden nodes, only 32 of the 144 input features from the dense network were used (e.g., a 78% reduction in input features), while still providing a large fraction (0.516 vs 0.611 LAUC, or about 84%) of the fully-connected detection performance on an in-time in-sample evaluation. Thus, by allowing antipolarized node splitting (16 nodes were added), the third column shows a 0.537 LAUC vs. 0.611 LAUC, or about 88% of detection.

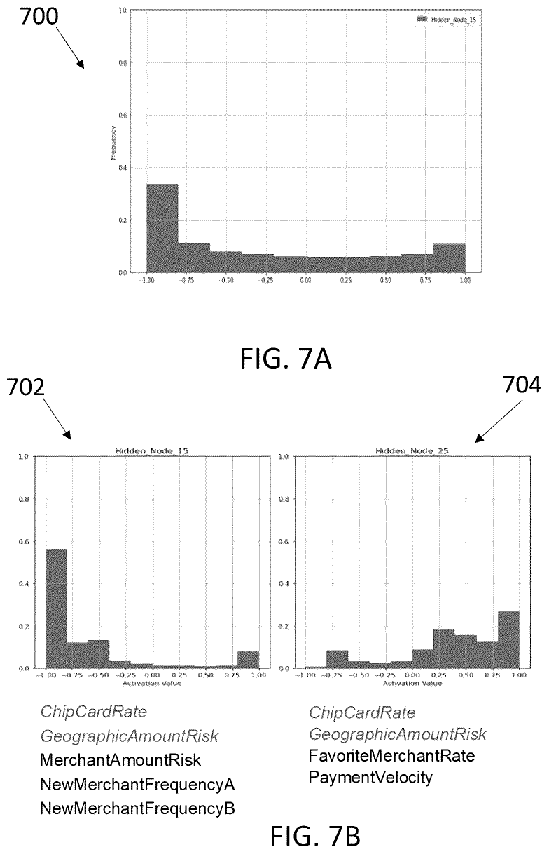

FIG. 7A illustrates an example distribution 700 of activation of hidden nodes in a dense network after training, consistent with implementations of the current subject matter. The distribution shown in FIG. 7A indicates the hidden node is antipolarized, consistent with implementations of the current subject matter, with significant activation at both positive and negative extremes. In this dense network, there were 18 hidden nodes, with 8 hidden nodes being split prior to training the sparse network due to the antipolarization of each of those hidden nodes. As a result, the sparse network had a total of 26 hidden nodes.

FIG. 7B illustrates a distribution of activation of a particular hidden node showing positive saturation (at 702) and negative saturation (at 704). For example, as noted above, this node was split, based on the original hidden node being determined as antipolarized, with a subset of the plurality of input features selected from when the unit saturated in each of its saturation modes. These new hidden nodes are more easily explained which allows the model to meet high levels of consistency in explainability. For example, in this case it is much easier to explain the nodes (at 702 or 704) as they have only five input features connected, as compared with the dense network where each input is connected to all 144 of the original input features. The ordered saturation list of input features under each distribution shows that only a small number of input features were selected based on the saturation of the corresponding hidden node. Two of the input features (e.g., ChipCardRate and GeographicAmountRisk) are common between the split nodes, however such input features may have opposite meanings in the new hidden nodes—the left hidden node may saturate with low ChipCardRate, while the right hidden node may saturate with high ChipCardRate.

Referring again to FIG. 2, at 210, the machine learning engine 110 may evaluate the generated sparse network (e.g., the retrained or sparsely trained machine learning model 120) with first-to-saturate activation. In contrast to conventional methods, the machine learning engine 110 may determine explanations based on the internal activations of the generated sparse network, and may not rely on external approximating models. The machine learning engine 110 generates the explanations independently for each training example (e.g., in contrast to certain conventional methods, which produce an overall feature ranking across the training examples).

Again referring to FIG. 2, at 212, the machine learning engine 110 generates an explanation per training example based on the sparse network (e.g., the retrained or sparsely trained machine learning model 120). The machine learning engine 110 generates the explanations with a backward pass to determine the relevant input features for head hidden node of the sparse network.

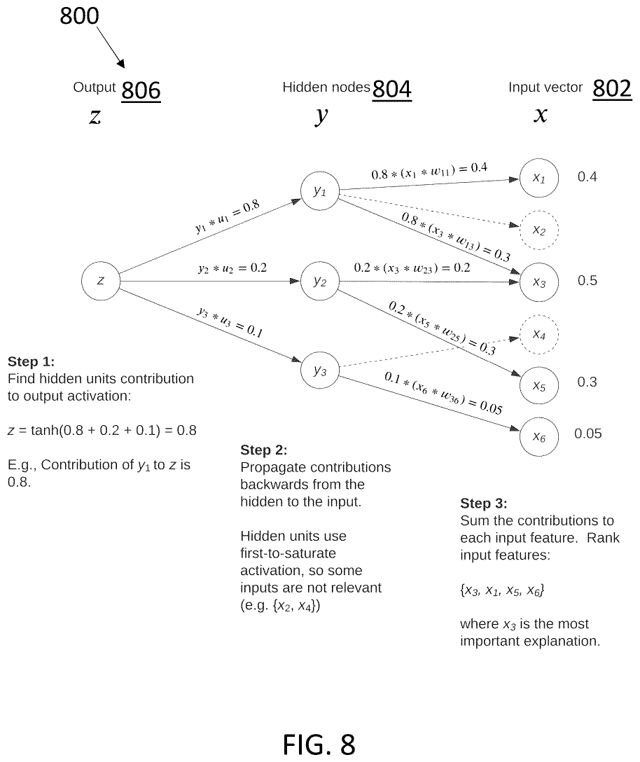

For example, FIG. 8 shows a process 800 for generating accurate and consistent explanations based on the sparsely trained machine learning model 120, consistent with implementations of the current subject matter. As shown in FIG. 8, the structure of the sparse network shows that some hidden units have no non-zero connection to at least some input features. For example, as shown in FIG. 8, hidden node y₁ is only connected to the input features {x₁, x₂, x₃}. The sparse network shown in FIG. 8 is depicted such that zero weight connections are not shown due to the inherently sparse architecture.

Referring to FIG. 8, at 806, the machine learning engine 110 determines a contribution of each hidden node of the sparsely trained machine learning model 120 (e.g., the sparse network) to the activation of the output node of the sparsely trained machine learning model 120. The machine learning engine 110 determines the contribution by determining the hidden nodes that are first to saturate the corresponding output node. For example, the subset of all hidden nodes and for those that saturate the relevant input features for saturated hidden nodes are based on the first-to-saturate ordering described herein. The output unit of the sparsely trained machine learning model 120 may be less likely to saturate than the hidden nodes, in which case, all hidden nodes are evaluated since every output must be explained regardless of the saturation status. Thus, in the example shown in FIG. 8, all of the hidden nodes are needed for the output to reach saturation.

At 804, for each hidden node of the sparsely trained machine learning model 120 (e.g., the sparse network), the machine learning engine 110 may back propagate the weighted contribution of the hidden nodes to the input vector including the plurality of input features (e.g., the subset of the plurality of input features or the ordered saturation list of the plurality of input features). For example, only a subset of input features are used until saturation is met and only those input features are attributed importance corresponding to the hidden node that the input features saturate. Hidden nodes not used in the output due to first-to-saturate have no contributions. Hidden nodes that have contributions to output node activations flow from the hidden nodes backward to the relevant input features. This results in a set of weighted input features, such as a hidden node weight contribution to the output, per each relevant hidden node. Explainability could stop only at the hidden nodes, as each hidden node provides some explanation of the cause of saturation, such as for the sparsely trained machine learning model described herein. In these cases, the observed saturation models are assigned a reason and those reasons are then provided in a set ordered by highest importance. In other instances, explanations will also flow to input features, as shown in FIG. 8.

Referring to FIG. 8, the hidden node weight contribution of the hidden nodes includes the contribution of the hidden node to the output unit. In this example, contributions from hidden node y₁ are weighted by 0.8, contributions from hidden node y₂ are weighted by 0.2, and contributions from hidden node y₃ are weighted by 0.1. Due to the first-to-saturate activation of the hidden nodes, some input features are not relevant to the activation of the corresponding hidden node. For example, as shown in FIG. 8, for hidden node y₁, only input features {x1, x3} are needed to saturate the hidden node y₁. As a result, input feature x₂ is not needed for explanation purposes. Also, a single input feature may be relevant to multiple hidden units (e.g., as shown in FIG. 8, x₃ is relevant to both hidden node y₁ and hidden node y₂.

At 802, for each of the relevant input features, the machine learning engine 110 determines a sum of the contributions from each of the selected hidden nodes. The machine learning engine 110 ranks (e.g., sorts) the corresponding input features by the sums, which are weighted contributions traced back (e.g., back propagated) from the output at 806, and which directly explain the output value of the sparsely trained machine learning model 120 (e.g., the sparse network). In other words, these identified input features constitute the input features responsible for the relevant hidden nodes and ultimately the output unit value of the sparsely trained machine learning model 120 (e.g., the sparse network).

For example, the machine learning engine 110 may determine a relative importance of the identified input features based on the hidden node ordered saturation list, the hidden node weight contribution, and a weight corresponding to the at least one input feature. The machine learning engine 110 may determine the relative importance of the at least one input feature, for the hidden node. The machine learning engine 110 may define the input feature-level contribution to the output by at least aggregating (e.g., summing) a list of most important input features based on the relative importance of the input features. Accordingly, the machine learning engine 110 reliably and consistently provides accurate explanations for the sparsely trained machine learning model 120.

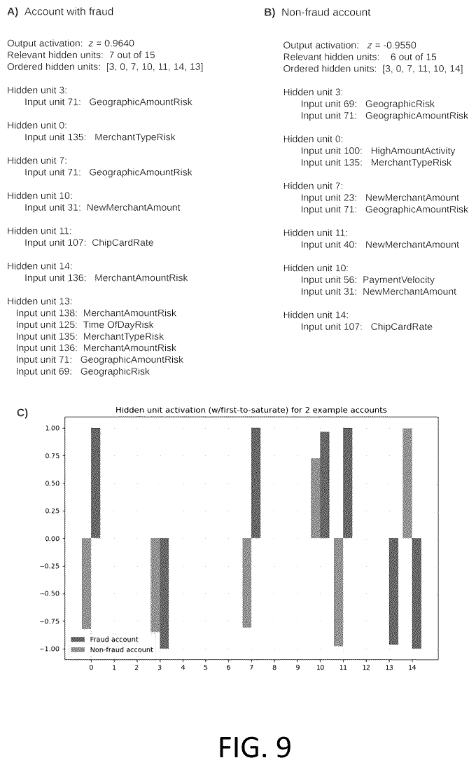

FIG. 9 illustrates example explanations generated by the explainable machine learning system 100, consistent with implementations of the current subject matter. To illustrate how input feature explanations are generated for specific examples, FIG. 9 shows two examples from a fraud detection use-case. As an example, a first-to-saturate sparse network was trained with 15 hidden units, and 18% (26/144) of the original input features. For each of the training examples, a subset of input features are found and the result is a concise explanation of the network's activations. For the fraud account case (shown at A), 47% (7/15) of the hidden nodes are needed to saturate the output unit, and 33% of the input features (9/27 unique) are found to be relevant to the explanation. For the non-fraud account case (shown at B), 40% (6/15) of the hidden units are needed to saturate the output unit, and 33% of the input features (9/27 unique) are found to be relevant to the explanation.

The input feature relevance can be summed over any of the hidden nodes that rely on that input feature, and then can be ranked and filtered to provide the final explanations to the user. For example, as shown in FIG. 9, many of the hidden nodes are driven by the input feature “GeographicAmountRisk”, which may be presented to the user as a single code with a description string such as “Behavior is risky for the geographic location and amount in recent transactions.” Many input features may be consolidated and represented by the same explanation code.

Referring again to FIG. 9, in the bar graph shown at C, the hidden unit activations are shown for both fraud accounts (A) and non-fraud accounts (B). Even though many of the same hidden nodes are relevant for both accounts, for many hidden nodes, the activations have opposite signs (e.g. hidden units 0, 3, 7, 11 and 14). Thus, this represents an example of an antipolarized hidden node having overlapping relevant input features.

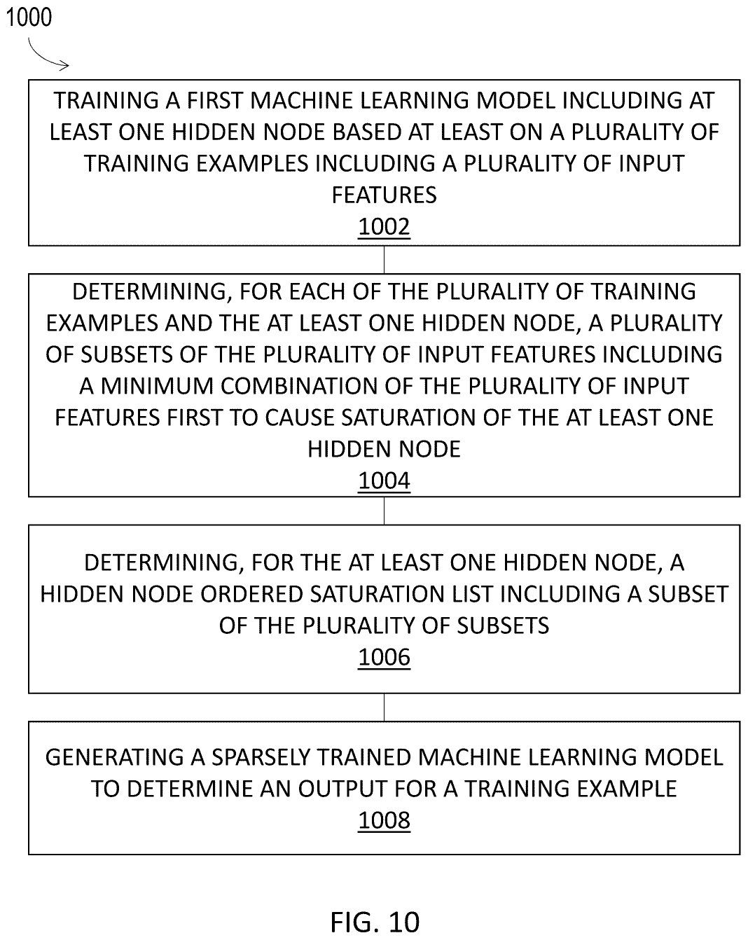

FIG. 10 depicts a flowchart illustrating a process 1000 for providing explanations of single modal latent feature activation networks using first-to-saturate latent features. Referring to FIGS. 1-10, one or more aspects of the process 1000 may be performed by the explainable machine learning system 100, the machine learning engine 110, other components therein, and/or the like.

At 1002, the machine learning engine 110 may train a first machine learning model (e.g., the machine learning model 120) including at least one hidden node. The at least one hidden node may include one or more hidden nodes. The first machine learning model may include a neural network or the like. The machine learning engine 110 may train the first machine learning model based at least on a plurality of training examples including a plurality of input features. Thus, the machine learning engine 110 may train the first machine learning model to generate a densely trained machine learning model based on all or a batch of input features of each of the plurality of training examples. In some implementations, each of the plurality of training examples includes an input vector containing the plurality of input features. As at least a part of training the machine learning model 120, the machine learning engine 110 may input, to the hidden node, the plurality of input features for each of the plurality of training examples in a predetermined order or a random order. The predetermined order may be based on a value of a weight assigned to each of the plurality of input features.

At 1004, the machine learning engine 110 may determine a plurality of subsets (e.g., a subset, one or more subsets, etc.) of the plurality of input features including a minimum combination of the plurality of input features first to cause saturation of the at least one hidden node. For example, the machine learning engine 110 may determine the plurality of subsets of the plurality of input features based at least on the dense network (e.g., the first machine learning model). The machine learning engine 110 may determine the plurality of subsets of the plurality of input features for each of the plurality of training examples and/or for the at least one hidden node.

The plurality of subsets of the plurality of input features causes saturation of the at least one hidden node when a weight contribution (e.g., a total weight contribution) of at least one of the plurality of subsets of the plurality of input features meets (e.g., is greater than or equal to) a predetermined saturation threshold. The predetermined saturation threshold may be 0.95, 0.90, 0.85, or the like. The predetermined saturation threshold indicates a threshold at which the hidden node is considered to be sufficiently saturated. The weight contribution may be determined by at least aggregating an absolute value of a weight assigned to each of the plurality of input features of the subset of the plurality of input features.

At 1006, the machine learning engine 110 determines a hidden node ordered saturation list including a subset of the plurality of subsets. The machine learning engine 110 may determine the hidden node ordered saturation list for the at least hidden node and based on the plurality of subsets of the plurality of input features for each of the plurality of training examples. The machine learning engine 110 may determine the hidden node ordered saturation list by at least determining a most frequently occurring subset of the plurality of subsets of the plurality of input features causing saturation of the at least one hidden node. Additionally and/or alternatively, the machine learning engine 110 may define the hidden node ordered saturation list as the most frequently occurring subset of input features of the plurality of subsets of the plurality of input features. In some implementations, determining the hidden node ordered saturation list of the at least one hidden node further includes ranking each input feature of the plurality of subsets of the plurality of input features based on at least one of a weight assigned to the input feature (e.g., assigned during the training of the first machine learning model) and a frequency of the input feature appearing within the subset of the plurality of input features across the plurality of training examples.

In some implementations, the machine learning engine 110 may determine a hidden node of the at least one hidden node is antipolarized. The machine learning engine 110 may determine the at least one hidden node is antipolarized based on a first proportion or ratio of the plurality of training examples meeting (e.g., is greater than or equal to) a positive saturation threshold and/or a second proportion of the plurality of training examples meeting (e.g., is greater than or equal to) a negative saturation threshold. This indicates that a sufficient quantity of the training examples (including subsets of the input features) positively and negatively saturate the hidden node.

In some implementations, based on determining the hidden node of the at least one hidden node is antipolarized, the machine learning engine 110 may replace the at least one antipolarized hidden node with a first newly created hidden node and a second newly created hidden node. In some implementations, such as when the hidden node of the at least one hidden node is antipolarized, the machine learning engine 110 determines the ordered saturation list of the at least one hidden node by at least determining, for the first newly created hidden node, a first hidden node ordered saturation list of the plurality of input features causing positive saturation of the at least one hidden node, and determining, for the second newly created hidden node, a second hidden node ordered saturation list of the plurality of input features causing negative saturation of the at least one hidden node. This may more accurately indicate an explanation for saturating the hidden node.

At 1008, the machine learning engine 110 generates a sparsely trained machine learning model. For example, the machine learning engine 110 may train the first machine learning model to predict an output for a training example of the plurality of examples based on at least one input feature of the subset included in the hidden node ordered saturation listcorresponding to the at least one hidden node. The at least one input feature first causes saturation of the at least one hidden node for the training example.

In some implementations, machine learning engine 110 generates the sparsely trained machine learning model by at least retraining the first machine learning model based on the ordered saturation list of the plurality of input features. The sparsely trained machine learning model may be a sparse neural network. In some implementations, the remaining input features that not included in the ordered saturation list may be assigned a zero weight or otherwise not contribute to predicting the output of the sparsely trained machine learning model.

In some implementations, the machine learning engine 110 may generate an explanation corresponding to at least one training example of the plurality of training examples. The explanation may include an input feature-level contribution to the output.

For example, the machine learning engine 110 may determine the at least one input feature of the subset first causing saturation of the at least one hidden node for the training example. Additionally and/or alternatively, the machine learning engine 110 may determine, for the at least one hidden node of the sparsely trained machine learning model, a hidden node weight contribution to the output, corresponding to the at least one input feature. This may indicate the contribution of the hidden node of the sparsely trained machine learning model.

Additionally and/or alternatively, the machine learning engine 110 may determine a relative importance of the at least one input feature of the subset based on the hidden node ordered saturation list, the hidden node weight contribution, and a weight corresponding to the at least one input feature. The machine learning engine 110 may determine the relative importance of the at least one input feature, for the at least one hidden node of the sparsely trained machine learning model.

Additionally and/or alternatively, the machine learning engine 110 may define the input feature-level contribution to the output by at least aggregating a list of most important input features based on the relative importance of the at least one input feature for each subset of the plurality of subsets.

In some implementations, when saturation of the at least one hidden node for the training example occurs prior to reaching an end of the hidden node ordered saturation list, at least one remaining input feature of the subset is ignored. Additionally and/or alternatively, when saturation of the at least one hidden node for the training example fails to occur prior to reaching an end of the hidden node ordered saturation list, the at least one input feature includes all input features of the subset.

### EXAMPLE EXPERIMENTS

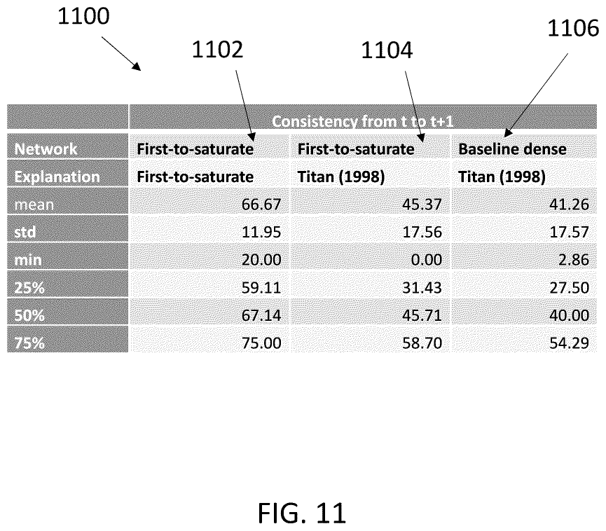

FIG. 11 illustrates a table 1100 showing a consistency comparison between the explainable machine learning system 100 consistent with implementations of the current subject matter and a conventional method. In particular, table 1100 shows a comparison between the explainable machine learning system 100 (shown in column 1102), a first-to-saturate network (e.g., sparse weights) using a baseline explanation method of the conventional method (shown in column 1104), and a standard dense neural network (e.g., fully connected) with the same input features, but otherwise none of the first-to-saturate process was used (shown in column 1106). For explanations, the conventional baseline method was used.

The conventional explanation method in this example produces example-level explanations. The conventional explanation method is agnostic to the classifier type used and can provide explanations for arbitrary classifiers (e.g., neural networks, support vector machines, etc.). This baseline method has two phases, one at training time and the other during evaluation. After classifier training, the method bins the output values and input feature values, and stores those for lookup during production evaluation. At evaluation, the method uses the correlation of output values with the feature values, and selects as the explanation those input features which are most correlated with the output value at that score range based on the representation learned on the training data. However, this method does not consider the classifier's internal calculation used to arrive at the output, in contrast with the explainable machine learning system 100, which may be directly driven by the structure of the machine learning model 120 and application of the first-to-saturate method to allow only one mode of saturation when a hidden mode is saturated.

First, the internal consistency between time steps t and t+1 was compared. For example, FIG. 11 shows statistics for the percentages of intersections between the top five input features selected as explanations. The statistics were found over a test set of approximately 150,000 transactions that included 5719 customers, each of whom had at least five transactions.

As shown in column 1102, the explainable machine learning system 100 has on average 67% intersection (e.g., approximately three of the top five explanations are the same) from t to t+1. As shown in column 1104, using the first-to-saturate network with the explanations from the conventional method, there is only a 45% mean interaction, so the explainable machine learning system 100 provides more internal consistency between time steps. Further, as shown in column 1106, comparing to a standard dense network with explanations from the conventional method, there is only 41% intersection, or approximately two of the top five input features. This shows that the explainable machine learning system 100 provides more internally consistent and accurate explanations across time compared with the conventional methods.

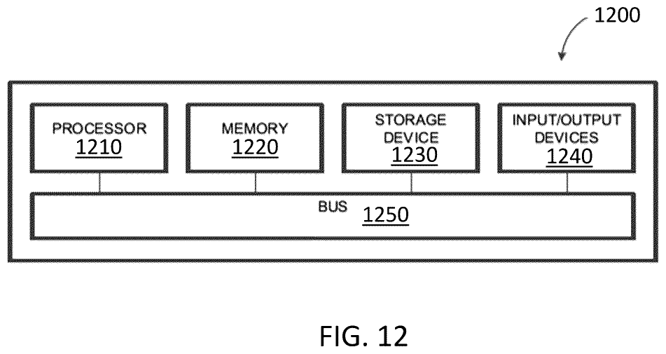

FIG. 12 depicts a block diagram illustrating a computing system 1200 consistent with implementations of the current subject matter. Referring to FIGS. 1-12, the computing system 1200 can be used to implement the explainable machine learning system 100, the machine learning engine 110, the machine learning model 120, and/or any components therein.

As shown in FIG. 12, the computing system 1200 can include a processor 1210, a memory 1220, a storage device 1230, and input/output devices 1240. The processor 1210, the memory 1220, the storage device 1230, and the input/output devices 1240 can be interconnected via a system bus 1250. The computing system 1200 may additionally or alternatively include a graphic processing unit (GPU), such as for image processing, and/or an associated memory for the GPU. The GPU and/or the associated memory for the GPU may be interconnected via the system bus 1250 with the processor 1210, the memory 1220, the storage device 1230, and the input/output devices 1240. The memory associated with the GPU may store one or more images described herein, and the GPU may process one or more of the images described herein. The GPU may be coupled to and/or form a part of the processor 1210. The processor 1210 is capable of processing instructions for execution within the computing system 1200. Such executed instructions can implement one or more components of, for example, the explainable machine learning system 100, the machine learning engine 110, the machine learning model 120, and/or the like. In some implementations of the current subject matter, the processor 1210 can be a single-threaded processor. Alternately, the processor 1210 can be a multi-threaded processor. The processor 1210 is capable of processing instructions stored in the memory 1220 and/or on the storage device 1230 to display graphical information for a user interface provided via the input/output device 1240.

The memory 1220 is a computer readable medium such as volatile or non-volatile that stores information within the computing system 1200. The memory 1220 can store data structures representing configuration object databases, for example. The storage device 1230 is capable of providing persistent storage for the computing system 1200. The storage device 1230 can be a floppy disk device, a hard disk device, an optical disk device, or a tape device, or other suitable persistent storage means. The input/output device 1240 provides input/output operations for the computing system 1200. In some implementations of the current subject matter, the input/output device 1240 includes a keyboard and/or pointing device. In various implementations, the input/output device 1240 includes a display unit for displaying graphical user interfaces.

According to some implementations of the current subject matter, the input/output device 1240 can provide input/output operations for a network device. For example, the input/output device 1240 can include Ethernet ports or other networking ports to communicate with one or more wired and/or wireless networks (e.g., a local area network (LAN), a wide area network (WAN), the Internet).

In some implementations of the current subject matter, the computing system 1200 can be used to execute various interactive computer software applications that can be used for organization, analysis and/or storage of data in various (e.g., tabular) format (e.g., Microsoft Excel®, and/or any other type of software). Alternatively, the computing system 1200 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1240. The user interface can be generated and presented to a user by the computing system 1200 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system comprising:
at least one data processor; and
at least one memory storing instructions, which when executed by the at least one processor result in operations comprising:
training, based at least on a plurality of training examples including a plurality of input features, a first machine learning model including at least one hidden node;
determining, for each of the plurality of training examples and the at least one hidden node and based on the first machine learning model, a plurality of subsets of the plurality of input features including a minimum combination of the plurality of input features first to cause saturation of the at least one hidden node;
determining, for the at least one hidden node and based on the plurality of subsets of the plurality of input features for each of the plurality of training examples, a hidden node ordered saturation list including a subset of the plurality of subsets; and
generating a sparsely trained machine learning model to determine an output for a training example of the plurality of training examples based on at least one input feature of the subset included in the hidden node ordered saturation list corresponding to the at least one hidden node, wherein the at least one input feature first causes saturation of the at least one hidden node for the training example.

2. The system of claim 1, wherein the operations further include generating an explanation corresponding to at least one training example of the plurality of training examples, wherein the explanation includes an input feature-level contribution to the output.

3. The system of claim 2, wherein generating the explanation includes:
determining the at least one input feature of the subset first causing saturation of the at least one hidden node for the training example;
determining, for the at least one hidden node of the sparsely trained machine learning model, a hidden node weight contribution to the output, wherein the hidden node weight contribution corresponds to the at least one input feature;
determining, for the at least one hidden node of the sparsely trained machine learning model, a relative importance of the at least one input feature of the subset based on the hidden node ordered saturation list, the hidden node weight contribution, and a weight corresponding to the at least one input feature; and
defining the input feature-level contribution to the output by at least aggregating a list of most important input features based on the relative importance of the at least one input feature for each subset of the plurality of subsets.

4. The system of claim 3, wherein when saturation of the at least one hidden node for the training example occurs prior to reaching an end of the hidden node ordered saturation list, at least one remaining input feature of the subset is ignored.

5. The system of claim 3, wherein when saturation of the at least one hidden node for the training example fails to occur prior to reaching an end of the hidden node ordered saturation list, the at least one input feature includes all input features of the subset.

6. The system of claim 1, wherein determining the ordered hidden node saturation list for the at least one hidden node includes determining a most frequently occurring subset of the plurality of subsets of the plurality of input features causing saturation of the at least one hidden node; and defining the ordered saturation list as the most frequently occurring subset of input features of the plurality of subsets of the plurality of input features.

7. The system of claim 1, wherein the plurality of subsets of the plurality of input features causes hidden node saturation of the least one hidden node when a weight contribution of at least one of the plurality of subsets of the plurality of input features is greater than a predetermined saturation threshold.

8. The system of claim 1, wherein determining the hidden node ordered saturation list of the at least one hidden node further includes ranking each input feature of the plurality of subsets of the plurality of input features based on at least one of a weight assigned to the input feature and a frequency of the input feature.

9. The system of claim 6, wherein the weight is assigned during the training of the first machine learning model.

10. The system of claim 1, wherein the training includes inputting the plurality of input features for each of the plurality of training examples in a predetermined order or a random order.

11. The system of claim 1, wherein the operations further include: determining a hidden node of the at least one hidden node is antipolarized based on a first proportion of the plurality of training examples meeting a positive saturation threshold and a second proportion of the plurality of training examples meeting a negative saturation threshold.

12. The system of claim 9, wherein the operations further comprise: replacing the at least one antipolarized hidden node with a first newly created hidden node and a second newly created hidden node, and wherein the determining the hidden node ordered saturation list of the at least one hidden node includes: determining, for the first newly created hidden node, a first hidden node ordered saturation list of the plurality of input features causing positive saturation of the at least one hidden node; and determining, for the second newly created hidden node, a second hidden node ordered saturation list of the plurality of input features causing negative saturation of the at least one hidden node.

13. The system of claim 1, wherein each of the plurality of training examples includes an input vector containing the plurality of input features.

14. The system of claim 1, wherein the subset includes one or more input features of the plurality of input features.

15. A computer implemented method, comprising:
training, based at least on a plurality of training examples including a plurality of input features, a first machine learning model including at least one hidden node;
determining, for each of the plurality of training examples and the at least one hidden node and based on the first machine learning model, a plurality of subsets of the plurality of input features including a minimum combination of the plurality of input features first to cause saturation of the at least one hidden node;
determining, for the at least one hidden node and based on the plurality of subsets of the plurality of input features for each of the plurality of training examples, a hidden node ordered saturation list including a subset of the plurality of subsets; and
generating a sparsely trained machine learning model to determine an output for a training example of the plurality of training examples based on at least one input feature of the subset included in the hidden node ordered saturation list corresponding to the at least one hidden node, wherein the at least one input feature first causes saturation of the at least one hidden node for the training example.

16. The method of claim 15, further comprising generating an explanation corresponding to at least one training example of the plurality of training examples, wherein the explanation includes an input feature-level contribution to the output, and wherein generating the explanation includes:
determining the at least one input feature of the subset first causing saturation of the at least one hidden node for the training example;
determining, for the at least one hidden node of the sparsely trained machine learning model, a hidden node weight contribution to the output, wherein the hidden node weight contribution corresponds to the at least one input feature;
determining, for the at least one hidden node of the sparsely trained machine learning model, a relative importance of the at least one input feature of the subset based on the hidden node ordered saturation list, the hidden node weight contribution, and a weight corresponding to the at least one input feature; and
defining the input feature-level contribution to the output by at least aggregating a list of most important input features based on the relative importance of the at least one input feature for each subset of the plurality of subsets.

17. The method of claim 15, wherein determining the ordered hidden node saturation list for the at least one hidden node includes determining a most frequently occurring subset of the plurality of subsets of the plurality of input features causing saturation of the at least one hidden node; and defining the ordered saturation list as the most frequently occurring subset of input features of the plurality of subsets of the plurality of input features.

18. The method of claim 15, wherein the plurality of subsets of the plurality of input features causes hidden node saturation of the least one hidden node when a weight contribution of at least one of the plurality of subsets of the plurality of input features is greater than a predetermined saturation threshold.

19. The method of claim 15, further comprising:
determining a hidden node of the at least one hidden node is antipolarized based on a first proportion of the plurality of training examples meeting a positive saturation threshold and a second proportion of the plurality of training examples meeting a negative saturation threshold;
replacing the at least one antipolarized hidden node with a first newly created hidden node and a second newly created hidden node,
wherein the determining the hidden node ordered saturation list of the at least one hidden node includes: determining, for the first newly created hidden node, a first hidden node ordered saturation list of the plurality of input features causing positive saturation of the at least one hidden node; and determining, for the second newly created hidden node, a second hidden node ordered saturation list of the plurality of input features causing negative saturation of the at least one hidden node.

20. A non-transitory computer-readable medium storing instructions, which when executed by at least one data processor, result in operations comprising:
training, based at least on a plurality of training examples including a plurality of input features, a first machine learning model including at least one hidden node;
determining, for each of the plurality of training examples and the at least one hidden node and based on the first machine learning model, a plurality of subsets of the plurality of input features including a minimum combination of the plurality of input features first to cause saturation of the at least one hidden node;
determining, for the at least one hidden node and based on the plurality of subsets of the plurality of input features for each of the plurality of training examples, a hidden node ordered saturation list including a subset of the plurality of subsets; and
generating a sparsely trained machine learning model to determine an output for a training example of the plurality of training examples based on at least one input feature of the subset included in the hidden node ordered saturation list corresponding to the at least one hidden node, wherein the at least one input feature first causes saturation of the at least one hidden node for the training example.
